(19) United States
(12) Patent Application Publication
(10) Pub. No.: US 2025/0118752 A1
(43) Pub. Date: Apr. 10, 2025

(54) HARD CARBON-DERIVED BATTERY ANODE MATERIAL

(71) Applicant: INGEVITY SOUTH CAROLINA, LLC, North Charleston, SC (US)

(72) Inventors: Ayumi Hyodo, North Charleston, SC (US); Billy-Paul M. Holbrook, North Charleston, SC (US)

(21) Appl. No.: 18/906,984

(22) Filed: Oct. 4, 2024

Related U.S. Application Data
(60) Provisional application No. 63/590,588, filed on Oct. 16, 2023.
(60) Provisional application No. 63/588,175, filed on Oct. 5, 2023.

(51) Int. Cl. H01M 4/587; C01B 32/05; H01M 4/02; H01M 4/133; H01M 4/62; H01M 10/054

(52) U.S. Cl. CPC H01M 4/587; C01B 32/05; H01M 4/133; H01M 4/623; H01M 10/054; C01P 2004/61; C01P 2006/12; C01P 2006/14; C01P 2006/40; H01M 2004/021; H01M 2004/027

(57) ABSTRACT

Presently described are saccharide-derived hard carbon materials and methods of making the same. The described materials are useful as electrochemical anode materials for metal-ion batteries, in particular, sodium ion batteries, as compared to currently available materials.

### CROSS-REFERENCE TO RELATED APPLICATIONS

This application claims the benefit of priority to U.S. Provisional Patent Application Ser. No. 63/588, 175, filed: 5 Oct. 2023, titled: Hard Carbon-Derived Battery Anode Material, and U.S. Provisional Patent Application Ser. No. 63/590,588, filed: 16 Oct. 2023, titled: Hard Carbon-Derived Battery Anode Material, each of which is hereby incorporated herein by reference in their entirety.

### BACKGROUND

### Field of the Discovery

The present disclosure, in various aspects and embodiments, relates to hard carbon-based, electrochemically active battery anode materials comprising a saccharide or saccharide substitute, methods of making and using the same.

### Background Information

Batteries with higher energy density and power density are essential for many applications including electric vehicles, grid storage, and portable electronics. Over the past few decades, lithium-ion batteries (LiBs) have proven to be the most popular choice for consumer electronics, primarily because of their high specific energy and energy density. However, rapid consumption, uneven terrestrial distribution, and increasing prices of Li precursors may limit further expansion of LiBs. Moreover, the raw materials for LiBs such as cobalt, lithium, and natural graphite are identified as critical resources by United States and Europe.

Graphite is the most popular anode material for LiBs due to its relatively high capacity and good cycling lifetime. However, the rate performance of graphite may limit its application in high-power systems. Additionally, LiB anodes tend to be highly optimized for performance at a relatively slow charging operation, and even if they are not, significant challenges are still present for fast charging conditions (e.g., >a C-rate of 4 C or less than 15-minute charge time). These challenges include large kinetic polarizations, concentration gradients, heat generation, and lithium (Li) metal plating on the graphite surface. As such, LiBs with graphite electrodes can suffer from reduced accessible capacity, low cycling efficiencies, and capacity fade.

Sodium-ion batteries (SiBs) are being developed as an alternative to LiBs. The working principle and cell construction of SiBs are similar to those of LiB types. For example, SiBs and LiBs include a cathode (positive electrode), an anode (negative electrode), and a liquid electrolyte. However, SiBs replace lithium-ion insertion cathode materials with sodium-ion insertion cathode materials. Sodium is an attractive alternative because of its natural global abundance. reduced environmental impact, and lower cost as compared to LiBs due to the fact that materials such as lithium, cobalt, copper and nickel are not strictly required for many types of sodium-ion batteries.

However, graphite cannot be used in SiBs. Sodium ions have a larger ionic radius (1.02 Å) than lithium ions (0.76 Å), and relatively high ionization potential (5.139 eV), so sodium ions cannot intercalate into graphite regions that typically have an interlayer spacing of about 0.335 nm. It was recently discovered that solvated sodium ions can intercalate in graphite despite the insertion of sodium ions alone is thermodynamically impossible. However, this approach adds further complications including the addition of a new component to the battery materials.

There are a variety of materials that have been studied as a potential anode for SiBs, such as alloys (phosphorus or tin), metal-based oxides/sulfides, and carbonaceous materials. Among them, a potential anode material for SiBs is non-graphitizable hard carbon. Compared to graphite, non-graphitizable carbon materials such as hard carbon tend to have a more homogeneous metal ion intercalation flux, and therefore, may display an improved rate capability. Non-graphitizable hard carbon also demonstrates good sodium-ion storage capacity and working potential, as well as providing environmental and cost advantages.

Common precursors of hard carbon include biomass (wood, coconut shells, coffee bean, fruit peels, leaves, sugar bagasse, rice straw), petroleum pitch, and polymers. However, these precursors contain significant amounts of impurities such as potassium, calcium, sulfur, and iron, requiring complex processes to remove them to qualify for the battery applications and meet the required sodiation capacity and capacity retention criteria. Additionally, hard carbon materials often suffer from low initial Coulombic efficiencies, indicating a significant initial irreversible capacity loss. This drawback significantly limits the overall capacity and energy density of the battery.

Therefore, there exists a need in the art for hard carbon-based, electrochemically active battery anode materials that address one or more of the shortcomings discussed above. For example, it would be advantageous to have hard carbon battery anode materials for sodium-ion batteries that are relatively inexpensive, abundant, have improved purity, and that provide robust electrochemical performance over time thus enabling higher cycle life.

### SUMMARY

Presently described are hard carbon-based, electrochemically active battery anode materials comprising at least one pyrolyzed or carbonized saccharide precursor, e.g., a monosaccharide, a disaccharide, an oligosaccharide, a polysaccharide, a saccharide substitute or a combination thereof (collectively, “saccharide-derived hard carbon”), methods of making and using the same. The saccharide-derived hard carbon as described herein performs surprisingly and unexpectedly well as an anode material in sodium-ion batteries (SiBs) displaying, for example, higher performance (specific density and capacity retention) as compared with commercially available hard carbons.

Thus, in an aspect, the description provides an electrochemically active anode material comprising at least one saccharide-derived hard carbon. In any aspect or embodiment described herein, the saccharide-derived hard carbon comprises at least one of a monosaccharide, disaccharide, oligosaccharide, polysaccharide, saccharide substitute or combination thereof. In any aspect or embodiment described herein, the saccharide-derived hard carbon comprises at least one of sucrose, sucralose, allulose or a combination thereof.

In any aspect or embodiment described herein, the saccharide-derived hard carbon has a mean or average particle size (D₅₀) of from about 2 μm to about 50 μm.

In any aspect or embodiment described herein, the saccharide-derived hard carbon has less than 1860 ppm of total impurities as determined by proton-induced X-ray emission (PIXE).

In any aspect or embodiment described herein, the saccharide-derived hard carbon comprises an effective pore volume as determined by carbon dioxide adsorption (p/p₀<0.03) of from 0.011 to 0.148 cm³/g.

In any aspect or embodiment described herein, the saccharide-derived hard carbon comprises a nitrogen Brunauer-Emmett-Teller (BET) specific surface area equal to or less than 47 m²/g.

In an additional aspect, the description provides an electrochemically active anode material comprising from about 85-98 wt % of a saccharide-derived hard carbon as described herein, from 1-5 wt % carbon black (e.g., C-Nergy Super C65; Imerys), and from 1-5 wt % binder (e.g., PVDF Kynar HSV 1800, CMC, SBR).

In any aspect or embodiment described herein, the binder is a polymer. In any aspect or embodiment described herein, the polymer binder comprises a fluoropolymer binder, e.g., a thermoplastic fluoropolymer, a cellulose derivative, e.g. carboxymethyl cellulose, a polymeric acid, e.g., polyacrylic acid. In any aspect or embodiment described herein, the fluoropolymer binder comprises polyvinylidene fluoride or polyvinylidene difluoride (PVDF).

In an additional aspect, the description provides a method of making an electrochemically active anode material comprising a saccharide-derived hard carbon as described herein.

In an additional aspect, the description provides a sodium-ion battery (SiB) comprising an electrochemically active anode material comprising a saccharide-derived hard carbon as described herein, a cathode, and an electrolyte.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 Demonstrates sodiation specific capacities (mAh/g) of saccharide-derived hard carbon samples A (sucrose), B (sucralose), C (sucralose), and D (sucralose) as compared with Commercial Benchmark hard carbons 1 (Carbotron®, petroleum pitch-based hard carbon; Kureha Corporation) and 2-1 (Kuranode™ plant-based hard carbon; Kuraray Co. Ltd). The cycles 1-5 were measured at C/10 rate, and cycles 6-9 at C/5.

FIG. 2 Demonstrates sodiation-de-sodiation profiles of initial cycle of Cell 1 of the saccharide-derived hard carbon samples A, B, C, and D as compared with Commercial Benchmark 1 and 2.

FIG. 3 Demonstrates sodiation specific capacities (mAh/g) of saccharide-derived hard carbon samples D (sucralose), E (sucralose), F (sucralose), G (sucralose), and H (raw sugar) as compared with Commercial Benchmark hard carbons 2-1 (Kuranode™ plant-based hard carbon; Kuraray Co. Ltd). The cycles 1-5 were measured at C/10 rate, cycles 6-10 at C/5, cycles 11-15 at C/2, cycles 16-20 at 1 C, and cycles 21-25 at C/10.

FIG. 4 Demonstrates sodiation specific capacities (mAh/g) of saccharide-derived hard carbon samples D (sucralose), I (walnut shells), J (cherry pits), and K (brazil nut shells) as compared with Commercial Benchmark hard carbons 2-1 (Kuranode™ plant-based hard carbon; Kuraray Co. Ltd). The cycles 1-5 were measured at C/10 rate, and cycles 6-9 at C/5.

### DETAILED DESCRIPTION

While various embodiments of the present disclosure are described herein, it will be understood by those skilled in the art that such embodiments are provided by way of example only. It will be understood by those skilled in the art that numerous modifications and changes to, and variations and equivalent substitutions of, the embodiments described herein can be made without departing from the scope of the disclosure. It is understood that various alternatives to the embodiments described herein may be employed in practicing the disclosure, and modifications may be made to adapt a particular structure or material to the teachings of the disclosure. It is also understood that every embodiment of the disclosure may optionally be combined with any one or more of the other embodiments described herein which are consistent with that embodiment.

Where elements are presented in list format (e.g., in a Markush group), it is understood that each possible subgroup of the elements is also disclosed, and any one or more elements can be removed from the list or group.

It is also understood that, unless clearly indicated to the contrary, in any method described or claimed herein that includes more than one act or step, the order of the acts or steps of the method is not necessarily limited to the order in which the acts or steps of the method are recited, but the disclosure encompasses embodiments in which the order is so limited.

It is further understood that, in general, where an embodiment in the description or the claims is referred to as comprising one or more features, the disclosure also encompasses embodiments that consist of, or consist essentially of, such feature(s).

It is also understood that any embodiment of the disclosure, e.g., any embodiment found within the prior art, can be explicitly excluded from the claims, regardless of whether or not the specific exclusion is recited in the specification.

Headings are included herein for reference and to aid in locating certain sections. Headings are not intended to limit the scope of the embodiments and concepts described in the sections under those headings, and those embodiments and concepts may have applicability in other sections throughout the entire disclosure.

All patent literature and all non-patent literature cited herein are incorporated herein by reference in their entirety to the same extent as if each patent literature or non-patent literature were specifically and individually indicated to be incorporated herein by reference in its entirety. In particular, the disclosures of U.S. Pat. Nos. 10,957,902 and 7,541,312 are incorporated herein by reference in their entirety for all purposes.

Unless otherwise defined, all technical and scientific terms used herein have the same meaning as commonly understood by one of ordinary skill in the art to which this invention belongs.

Where a range of values is provided, it is understood that each intervening value between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The term “exemplary” as used herein means “serving as an example, instance or illustration”. Any embodiment or feature characterized herein as “exemplary” is not necessarily to be construed as preferred or advantageous over other embodiments or features.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “cither,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

As used herein in the specification and in the claims, the phrase “at least one,” in reference to a list of one or more elements, should be understood to mean at least one element selected from anyone or more of the elements in the list of elements, but not necessarily including at least one of each and every clement specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “about” or “approximately” means an acceptable error for a particular value as determined by one of ordinary skill in the art, which depends in part on how the value is measured or determined. In certain embodiments, the term “about” or “approximately” means within one standard deviation. In some embodiments, when no particular margin of error (e.g., a standard deviation to a mean value given in a chart or table of data) is recited, the term “about” or “approximately” means that range which would encompass the recited value and the range which would be included by rounding up or down to the recited value as well, taking into account significant figures. In certain embodiments, the term “about” or “approximately” means within 10% or 5% of the specified value. Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values.

Whenever the term “at least” or “greater than” precedes the first numerical value in a series of two or more numerical values, the term “at least” or “greater than” applies to each one of the numerical values in that series of numerical values.

Whenever the term “no more than” or “less than” precedes the first numerical value in a series of two or more numerical values, the term “no more than” or “less than” applies to each one of the numerical values in that series of numerical values.

Sodium-ion batteries (SiBs) are economically advantageous compared to lithium-ion batteries (LiBs) due to the relative abundance of source materials, which lowers the price and liberates concentrated supply chains. However, technologies used for SiB and LiB anodes are not interchangeable and SiB anodes require a material that can intercalate sodium ions. Hard carbon (disordered graphitic carbon) has received interest as a potentially useful material for lithium-ion batteries. However, the use of hard carbons, particularly saccharide-derived hard carbons for use in sodium-ion batteries, e.g., sugar, has yielded inconclusive results, and the use of sugar substitutes has not been evaluated at all.

Presently described are hard carbon-based, electrochemically active battery anode materials comprising at least one pyrolyzed or carbonized saccharide precursor, e.g., a sugar, such as, e.g., a monosaccharide or a disaccharide; an oligosaccharide; a polysaccharide; a saccharide substitute, e.g., a sugar substitute; or a combination thereof (collectively, “saccharide-derived hard carbon”), methods of making and using the same. The saccharide-derived hard carbons as described herein perform surprisingly and unexpectedly well as an anode material in sodium-ion batteries (SiBs) displaying, for example, better performance (e.g., specific density and capacity retention) as compared with commercially available hard carbons. In particular, hard carbon samples derived from sugar (e.g., sucrose, raw sugar) and sugar substitutes (e.g., sucralose, allulose, aspartame, xylitol, saccharin) were tested in sodium metal half cells and compared with two commercially available hard carbons formed from pitch (Carbotron®; Kurcha Corporation) or plant-based material (Kuranode®; Kuraray Co. Ltd).

Thus, in an aspect, the disclosure provides an electrochemically active anode material comprising at least one saccharide-derived hard carbon. In any aspect or embodiment described herein, the saccharide-derived hard carbon comprises at least one of a monosaccharide, disaccharide, oligosaccharide, polysaccharide, saccharide substitute or combination thereof. In any aspect or embodiment described herein, the saccharide-derived hard carbon comprises a sugar-derived hard carbon, sugar substitute-derived hard carbon or a combination thereof. In any aspect or embodiment described herein, the sugar-derived hard carbon comprises at least one of glucose, fructose, galactose, sucrose, lactose, maltose or a combination thereof. In any aspect or embodiment described herein, the sugar substitute-derived hard carbon comprises at least one of sucralose, allulose, aspartame, xylitol, saccharin or a combination thereof. In any aspect or embodiment described herein, the saccharide-derived hard carbon comprises at least one of glucose, fructose, galactose, sucrose, lactose, maltose, sucralose, allulose, aspartame, xylitol, saccharin or a combination thereof.

In any aspect or embodiment described herein, the saccharide-derived hard carbon comprises at least one of ethylene glycol (2-carbon), glycerol (3-carbon), erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), maltotriitol (18-carbon), maltotetraitol (24-carbon), polyglycitol, glucose (dextrose), dextrin (malto-, cyclo-), or a combination thereof.

In any aspect or embodiment described herein, the saccharide-derived hard carbon (e.g., the sugar-derived or sugar substitute-derived hard carbon) has an average particle size (D₅₀) of from about 2 μm to about 50 μm, from about 3 μm to about 50 μm, from about 4 μm to about 50 μm, from about 5 μm to about 50 μm, from about 2 μm to about 50 μm, from about 2 μm to about 45 μm, from about 2 μm to about 40 μm, from about 2 μm to about 35 μm, from about 2 μm to about 30 μm, or from about 2 μm to about 25 μm. In any aspect or embodiment described herein, the saccharide-derived hard carbon (e.g., the sugar-derived or sugar substitute-derived hard carbon) has an average particle size (D₅₀) of from about 5 μm to about 45 μm, from about 5 μm to about 40 μm, from about 5 μm to about 35 μm, from about 5 μm to about 30 μm, from about 5 μm to about 25 μm, from about 5 μm to about 20 μm or from about 5 μm to about 15 μm. In any aspect or embodiment described herein, the saccharide-derived hard carbon has an average particle size (D₅₀) of from about 5 μm to about 20 μm, from about 10 to about 20 or from about 10 μm to about 19 μm.

In any aspect or embodiment described herein, the saccharide-derived hard carbon (e.g., the sugar-derived or sugar substitute-derived hard carbon) comprises less than about 3000 ppm, less than about 2500 ppm, less than about 2000 ppm, less than about 1500 ppm, less than about 1300 ppm, less than about 1250 ppm, less than about 1200 ppm, less than about 1150 ppm, or less than about 1100 ppm of total impurities as determined by proton-induced X-ray emission (PIXE). In any aspect or embodiment described herein, the saccharide-derived hard carbon (e.g., the sugar-derived or sugar substitute-derived hard carbon) comprises less than about 1859 ppm of total impurities as determined by proton-induced X-ray emission (PIXE). In any aspect or embodiment described herein, the saccharide-derived hard carbon (e.g., the sugar-derived or sugar substitute-derived hard carbon) comprises from about 25 to about 1200 ppm, from about 50 to about 1200 ppm, from about 50 to about 1100 ppm, from about 50 to about 1000 ppm, from about 50 to about 900 ppm, from about 50 to about 800 ppm, or from about 55 to about 1860 ppm of total impurities as determined by proton-induced X-ray emission (PIXE).

In any aspect or embodiment described herein, the saccharide-derived hard carbon (e.g., the sugar-derived or sugar substitute-derived hard carbon) comprises an effective pore volume as determined by carbon dioxide adsorption (p/p₀<0.03) of from about 0.011 to about 0.148, from about 0.005 to about 0.20, from about 0.005 to about 0.195, from about 0.005 to about 0.19, from about 0.005 to about 0.185, from about 0.005 to about 0.18, from about 0.005 to about 0.175, from about 0.005 to about 0.17, from about 0.005 to about 0.165, from about 0.005 to about 0.16, from about 0.005 to about 0.155, from about 0.005 to about 0.15, from about 0.01 to about 0.195, from about 0.01 to about 0.185, from about 0.01 to about 0.175, from about 0.01 to about 0.165, from about 0.01 to about 0.155, or from about 0.01 to about 0.15 cm³/g.

In any aspect or embodiment described herein, the saccharide-derived hard carbon (e.g., the sugar-derived or sugar substitute-derived hard carbon) comprises a nitrogen Brunauer-Emmett-Teller (BET) specific surface area of from about ND (not detected) to about 60, from about ND to about 55, from about ND to about 50, from about 0.75 to about 60, from about 0.75 to about 55, from about 0.75 to about 50, from about 1 to about 60, from about 1 to about 55, or from about ND (not detected) to about 47 m²/g.

In any aspect or embodiment described herein, the electrochemically active anode material comprises at least one saccharide-derived hard carbon (e.g., the sugar-derived or sugar substitute-derived hard carbon), a conductive additive, and a binder. In any aspect or embodiment described herein, the electrochemically active anode material comprises from about 65 wt % to about 98 wt %, from about 70 wt % to about 98 wt %, from about 75 wt % to about 98 wt %, from about 80 wt % to about 98 wt %, from about 85 wt % to about 98 wt %, or about 90 wt % of at least one saccharide-derived hard carbon as described herein.

In any aspect or embodiment described herein, the conductive additive comprises multiwall carbon nanotubes, single-wall carbon nanotubes, carbon nanofibers, carbon black, acetylene black or a combination thereof. In any aspect or embodiment described herein, the electrochemically conductive anode material comprises from about 0.5 wt % to about 10 wt %, from about 0.5 wt % to about 9 wt %, from about 0.5 wt % to about 8 wt %, from about 0.5 wt % to about 7 wt %, from about 0.5 wt % to about 6 wt %, from about 0.5 wt % to about 5 wt %, from about 0.5 wt % to about 4 wt %, from about 1 wt % to about 10 wt %, from about 1 wt % to about 9 wt %, from about 1 wt % to about 8 wt %, from about 1 wt % to about 7 wt %, from about 1 wt % to about 6 wt %, or from about 1 wt % to about 5 wt % carbon black.

In any aspect or embodiment described herein, the anode binder material comprises from about 0.5 wt % to about 10 wt %, from about 0.5 wt % to about 9 wt %, from about 0.5 wt % to about 8 wt %, from about 0.5 wt % to about 7 wt %, from about 0.5 wt % to about 6 wt %, from about 0.5 wt % to about 5 wt %, from about 0.5 wt % to about 4 wt %, from about 0.5 wt % to about 3 wt %, from about 1 wt % to about 10 wt %, from about 1 wt % to about 9 wt %, from about 1 wt % to about 8 wt %, from about 1 wt % to about 7 wt %, from about 1 wt % to about 6 wt %, or 1 wt % to about 5 wt %.

In any aspect or embodiment described herein, the binder is an organic or inorganic binder. In any aspect or embodiment described herein, the binder comprises a polymer. In any aspect or embodiment described herein, the polymer comprises a fluoropolymer, a cellulose derivative salt, a polymeric acid, alginate In any aspect or embodiment described herein, the fluoropolymer comprises at least one of polyvinylidene fluoride, polyvinylidene difluoride (PVDF), carboxymethyl cellulose (CMC), methyl cellulose, styrene-butadiene (SBR), poly(acrylic) acid, alginate, poly(vinyl) alcohol or a combination thereof.

In certain embodiments, the description provides a hard carbon-based, electrochemically active battery anode material comprising a pyrolyzed or carbonized sugar or sugar substitute precursor (i.e., a sugar-derived hard carbon or sugar substitute-derived hard carbon, respectively). In certain embodiments, the hard carbon-based, electrochemically active battery anode material comprises one or more of: a sugar-derived hard carbon comprises at least one of glucose, fructose, galactose, sucrose, lactose, maltose or a combination thereof; a sugar substitute-derived hard carbon comprises at least one of sucralose, allulose, aspartame, xylitol, saccharin or a combination thereof (e.g., at from about 65 wt % to about 98 wt %); wherein the sugar-derived hard carbon or sugar substitute-derived hard carbon has an average particle size (D₅₀) of from about 2 μm to about 30 μm; wherein the sugar-derived hard carbon or sugar substitute-derived hard carbon comprises less than about 2500 ppm of total impurities as determined by proton-induced X-ray emission (PIXE); wherein the sugar-derived hard carbon or sugar substitute-derived hard carbon has an effective pore volume as determined by carbon dioxide adsorption (p/p₀<0.03) of from about 0.01 to about 0.15 cm³/g; wherein the sugar-derived hard carbon or sugar substitute-derived hard carbon has a nitrogen Brunauer-Emmett-Teller (BET) specific surface area less than 130 m2/g; a conductive additive (e.g., at from about 0.5 wt % to about 10 wt %); a binder (e.g., at from about 0.5 wt % to about 10 wt %), or a combination thereof. In certain embodiments, the conductive additive comprises carbon black, and/or the binder is a fluoropolymer as described herein.

In an additional aspect, the description provides a method of making an electrochemically active a hard carbon node material comprising a saccharide-derived hard carbon (e.g., the sugar-derived or sugar substitute-derived hard carbon) as described herein, comprising the steps of providing at least one of a saccharide or saccharide substitute precursor as described herein or combination thereof, and pyrolyzing or carbonizing at a temperature of from about 1000° C. to about 1600° C. (e.g., from about 1100° C. to about 1400° C., about 1000° C., about 1250° C., or about 1400° C.) to form a saccharide-derived hard carbon; and optionally, combining the saccharide-derived hard carbon with at least one of a conductive additive, a binder or combination thereof. In certain embodiments, the pyrolyzing step further includes pyrolyzing at a ramp rate of from 0.1° C./min to 20° C./min from 20 to 250° C., about 0.1° C./min to 20° C./min from 250 to 450° C., and about 0.1° C./min to 20° C./min from 450° C. to the set point. In certain embodiments, the pyrolyzing step further includes pyrolyzing at a ramp rate of from 0.5° C./min to 10° C./min from 20 to 250° C., about 0.5° C./min to 10° C./min from 250 to 450° C., and about 0.5° C./min to 10° C./min from 450° C. to the set point. In certain embodiments, the pyrolyzing step further includes pyrolyzing at a ramp rate of from 0.5° C./min to 5° C./min from 20 to 250° C., about 0.5° C./min to 5° C./min from 250 to 450° C., and about 0.5° C./min to 5° C./min from 450° C. to the set point. In certain embodiments, the pyrolyzing step further includes pyrolyzing at a ramp rate of from 0.5° C./min to 3° C./min from 20 to 250° C., about 0.5° C./min to 3° C./min from 250 to 450° C., and about 0.5° C./min to 3° C./min from 450° C. to the set point. In certain embodiments, the pyrolyzing step further includes pyrolyzing at a ramp rate of about 2.5° C./min from 20 to 250° C., about 1° C./min from 250 to 450° C., and about 2.5° C./min from 450° C. to the set point.

In certain embodiments, the method includes a step of dewatering the saccharide or saccharide substitute precursor prior to pyrolyzing or carbonizing. In certain embodiments, the dewatering step is performed at a temperature of from about 140° C. to about 240° C. (e.g., from about 140° C. to about 230° C., 140° C. to about 220° C., from about 140° C. to about 210° C., from about 140° C. to about 200° C., from about 140° C. to about 185° C., 185° C. or 145° C.).

In certain embodiments, subsequent to dewatering, the method includes a step of milling the dewatered saccharide or saccharide substitute precursor to a particle size (D₅₀) of from about 5 μm to about 150 μm, from about 10 μm to about 150 μm, from about 20 μm to about 150 μm, from about 30 μm to about 150 μm, from about 40 μm to about 150 μm, from about 50 μm to about 150 μm, from about 5 μm to about 140 μm, from about 5 μm to about 130 μm, from about 5 μm to about 120 μm, from about 5 μm to about 110 μm, from about 5 μm to about 100 μm, from about 20 μm to about 100 μm, from about 30 μm to about 100 μm, from about 5 μm to about 90 μm, from about 5 μm to about 80 μm, from about 5 μm to about 70 μm, from about 5 μm to about 60 μm, from about 5 μm to about 50 μm, from about 5 μm to about 40 μm, from about 5 μm to about 30 μm, from about 5 μm to about 20 μm, or from about 10 μm to about 20 μm.

In an additional aspect, the description provides a sodium-ion battery (SiB) comprising an electrochemically active anode material as described herein, including a saccharide-derived hard carbon (e.g., the sugar-derived or sugar substitute-derived hard carbon); a cathode, and an electrolyte. In certain embodiments, the saccharide-derived hard carbon comprises at least one of a monosaccharide, disaccharide, oligosaccharide, polysaccharide, saccharide substitute or combination thereof. In certain embodiments, the sugar-derived hard carbon comprises at least one of glucose, fructose, galactose, sucrose, lactose, maltose or a combination thereof. In certain embodiments, the sugar substitute-derived hard carbon comprises at least one of sucralose, allulose, aspartame, xylitol, saccharin or a combination thereof.

In certain embodiments, the sodium-ion battery (SiB) comprising the electrochemically active hard carbon anode material as described herein (e.g., the sugar-derived or sugar substitute-derived hard carbon) has a greater first sodiation specific capacity as compared to one comprising pitch-based or plant-based hard carbon anode materials. In certain embodiments, the electrochemically active hard carbon anode material as described herein has a first sodiation specific capacity of greater than 1%, 2%, 3%, 4%, 5%, 11%, 12%, 13%, 14%, 15%, 16%, 17%, 18%, 19%, 20% or more as compared to one comprising pitch-based or plant-based hard carbon anode materials.

In any aspect or embodiment, the sodium-ion battery (SiB) comprising an electrochemically active anode material as described herein (e.g., the sugar-derived or sugar substitute-derived hard carbon) comprises at least one of the following: a) a first sodiation specific capacity (mAh/g) of from about 325 to about 390, or from about 330 to about 385, about 336, about 342, about 364, or about 386 mAh/g; b) a reversible capacity (mAh/g) of from about 265 to about 310, from about 270 to about 310, from about 275 to about 310, from about 280 to about 310, from about 285 to about 310, about 273, about 289, about 298, or about 303 mAh/g.

### EXAMPLES

The following examples serve to demonstrate exemplary embodiments of the invention as compared to currently available materials and is not limiting on the scope of the disclosure.

Hard carbon samples derived from sugar (sucrose) and sugar substitutes (sucralose) were tested in sodium metal half cells at NEI Corporation. Two commercial benchmark samples (Commercial Benchmark 1 and 2) were tested.

Hard carbon samples, Sample A was produced using sugar (sucrose), Samples B-G were produced using a sugar-substitute (sucralose), Sample H was produced using raw sugar (sucrose with relatively high impurities) (See Tables and Figures). The precursor material was first dewatered in air at about 160-205° C. for about 24 hours and milled to mean particle size (D₅₀) of 20-100 μm. The dewatered material was then pyrolyzed in nitrogen (9 L/min) at about 1100-1400° C. with heating rates of about 2.5° C./min from 20 to 250° C., about 1° C./min from 250 to 450° C., and about 2.5° C./min from 450° C. to the set point. The dwell time was 1 hour. The sample was cooled to 25° C. The produced hard carbon was then ground to D₅₀ of 10-20 μm.

The electrochemical properties were measured using sodium metal half cells assembled with an exemplary combination comprising about 90 wt % of the sugar or sugar substitute-based hard carbon sample, about 5 wt % carbon black as a conducting material (commercially available as Imerys C-Nergy Super C65, and about 5 wt % Kynar HSV 1800 PVDF as a binder, and galvanostatically charged (de-sodiation) and discharged (sodiation) in a voltage range of 0.01-2.0 V (vs Na⁺/Na) at C/10 rate (C/10 CC-CV sodiation with CV cut-off at C/50, C/10 CC de-sodiation) for 1-5 cycles, and at C/5 rate (C/5 CC sodiation, C/5 CC de-sodiation) from 6-9 cycles at NEI Corp.

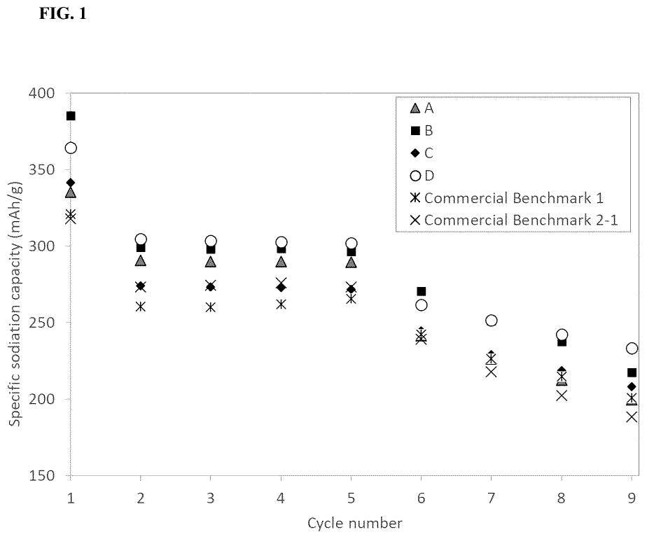

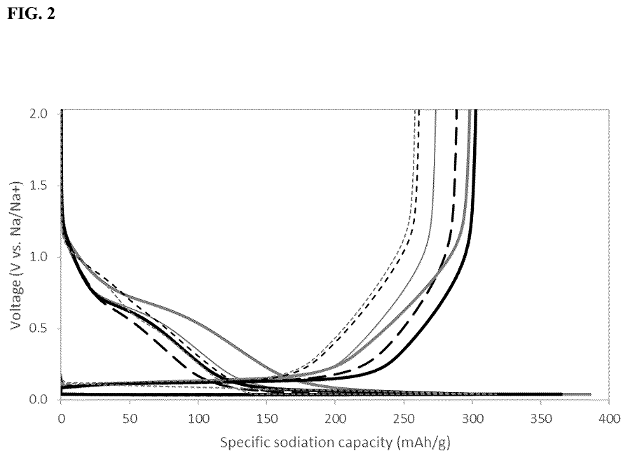

The hard carbon Samples A-H showed a maximum of 21.4% higher first sodiation specific capacity (336-386 mAh/g) than commercial hard carbon (321 mAh/g and 318 mAh/g for Commercial Benchmark 1 and 2-1, respectively) (FIGS. 1 and 2; Table 1).

The initial Coulombic efficiencies (ICE) or First Cycle Efficiency (FCE) are higher or similar to those of Commercial Benchmark samples (Table 1). Coulombic efficiency is determined by calculating the ratio of the de-sodiation capacity and the sodiation capacity in the same cycle.

The first reversible capacities of the hard carbon Samples A-D were 273-303 mAh/g whereas the Commercial Benchmark 1 and 2-1 were 261 mAh/g and 262 mAh/g, respectively (FIGS. 1 and 2; Table 1).

TABLE 1
Hard carbon properties of Exemplary Samples A, B, C, and D as compared to Commercial Benchmark 1 and 2.

| | | Dewater/ | | | First specific | | | |
|---|---|---|---|---|---|---|---|---|
| | | Carbonization | Pyrolysis | Pyrolysis | sodiation | Reversible | Irreversible | Initial |
| | | temperature | temperature | ramp rate | capacity | capacity | capacity | Coulombic |
| Sample ID | Raw material | (° C.) | (° C.) | (° C.) | (mAh/g) | (mAh/g) | (mAh/g) | efficiency (%) |
| A | Sucrose | 185 | 1400 | 2.5-1-2.5 | 336 | 289 | 47 | 86.0 |
| B | Sucralose | 185 | 1100 | 2.5-1-2.5 | 386 | 298 | 88 | 77.3 |
| C | Sucralose | 185 | 1250 | 2.5-1-2.5 | 342 | 273 | 69 | 80.0 |
| D | Sucralose | 185 | 1400 | 2.5-1-2.5 | 364 | 303 | 61 | 83.0 |
| E | Sucralose | 185 | 1400 | 2.5-1-2.5 | 370 | 302 | 67 | 81.8 |
| F | Sucralose | 205 | 1400 | 2.5-1-2.5 | 377 | 298 | 79 | 79.2 |
| G | Sucralose | 160 | 1400 | 2.5-1-2.5 | 361 | 291 | 70 | 80.7 |
| H | Raw sugar | 185 | 1400 | 2.5-1-2.5 | 370 | 298 | 72 | 80.6 |
| Commercial Benchmark 1 | — | — | — | — | 321 | 261 | 60 | 81.3 |
| Commercial Benchmark 2-1 | — | — | — | — | 318 | 262 | 56 | 82.5 |
| Commercial Benchmark 2-2 | — | — | — | — | 270 | 213 | 57 | 79.1 |

The interlayer spacing (d₀₀₂) of hard carbon Samples A-D determined by Rigaku Multipurpose X-ray Diffractometer (XRD) using Cu-Kα radiation (1.5418 Å) ranged from 0.382 to 0.395 nm. Their lateral size of the graphene domains (La) ranged from 2.574 to 3.481 nm, and thickness of the graphene layers stacking (Lc) from 0.873 to 1.022 nm (Table 2).

The interlayer spacing (d₀₀₂) is calculated using Bragg's law:

$${d}_{002} = \frac{λ}{2 sin θ}$$

where λ is the wavelength of the X-ray (0.15418 nm), θ is the glancing angle.

The graphene sheet stack thickness Lc and in-plane domain size La are calculated using Scherer equation:

$$L = \frac{K λ}{β cos θ}$$

where λ is the wavelength of the X-ray (0.15418 nm), β and θ are the full width at half maximum (FWHM) and scattering angle of the (002) or (100) peak, respectively. K is a form factor that is 0.89 for Lc and 1.84 for La.

The Brunauer-Emmett-Teller (BET) specific surface area measured by nitrogen adsorption ranged from ND (not detected) to 47 m²/g (Table 2).

The effective pore volume measured by carbon dioxide adsorption (p/p₀<0.03) ranged from 0.011 to 0.148 cm³/g (Table 2).

The I_{D}/I_{G}, ratio of peak intensity at 1350 cm⁻¹ and 1600 cm⁻¹ measured by Raman spectroscopy (532 nm laser) ranged from 1.995 to 3.050 (Table 2).

The ratios O/C (oxygen atoms to carbon atoms) and H/C (hydrogen atoms to carbon atoms) determined by CHNO elemental analysis are 0.007-0.025 and 0.060-0.142, respectively (Table 2).

The total impurities determined by PIXE (proton-induced X-ray emission) analyses are less than about 1860 ppm (Table 2).

The electrochemical results suggest a good battery performance, and hard carbon derived from sugar or sugar-substitutes may be a candidate as a high-performance sodium-ion battery (SiB) anode material.

Samples A and D perform 11-16% better than Commercial Benchmark 1, although Samples A and D and Commercial Benchmark 1 have similar carbon properties (BET surface area based on N₂ adsorption, effective pore volume based on CO₂ adsorption, d₀₀₂, La, I_{D}/I_{G}) (FIGS. 1 and 2; Tables 1 and 2).

Samples B and C have different hard carbon characteristics from Commercial Benchmark 1 (especially effective pore volume based on CO₂ adsorption) and performs 5-14% better than Commercial Benchmark 1.

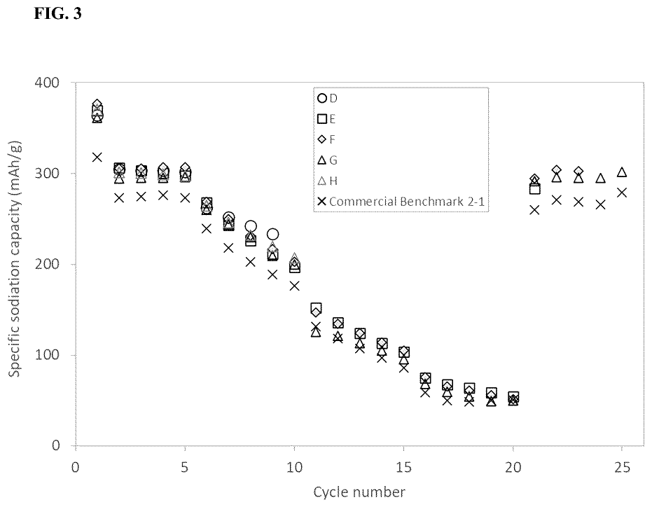

Sample D, E, F, G, and H have similar battery performance and similar carbon properties (BET surface area based on N₂ adsorption, effective pore volume based on CO₂ adsorption, d₀₀₂, La, I_{D}/I_{G}) (FIGS. 1 and 3; Tables 1 and 2).

TABLE 2
Hard carbon properties of Exemplary Samples A, B, C, and D as compared to Commercial Benchmark 1 and 2.

| | | | | | | | Effective |
|---|---|---|---|---|---|---|---|
| | | Dewater/ | | | | BET | pore |
| | | Carbonization | Pyrolysis | Pyrolysis | | surface | volume |
| | | temperature | temperature | ramp rate | D(50) | area N₂ | CO₂ |
| Sample ID | Raw material | (° C.) | (° C.) | (° C.) | (um) | (m²/g) | (cm³/g) |
| A | Sucrose | 185 | 1400 | 2.5-1-2.5 | 16.1 | 2 | 0.011 |
| B | Sucralose | 185 | 1100 | 2.5-1-2.5 | 14.6 | 47 | 0.148 |
| C | Sucralose | 185 | 1250 | 2.5-1-2.5 | 18.7 | ND | 0.119 |
| D | Sucralose | 185 | 1400 | 2.5-1-2.5 | 15.3 | 2 | 0.027 |
| E | Sucralose | 185 | 1400 | 2.5-1-2.5 | 15.0 | ND | 0.063 |
| F | Sucralose | 205 | 1400 | 2.5-1-2.5 | 9.8 | 40 | 0.064 |
| G | Sucralose | 160 | 1400 | 2.5-1-2.5 | 13.9 | 29 | 0.048 |
| H | Raw sugar | 185 | 1400 | 2.5-1-2.5 | 10.0 | 3 | 0.017 |

| | | | | | | |
|---|---|---|---|---|---|---|
| Commercial Benchmark 1 | — | — | — | 5.4 | 7 | 0.004 |
| Commercial Benchmark 2-1 | — | — | — | — | — | — |
| Commercial Benchmark 2-2 | — | — | — | 9.2 | 5 | 0.008 |

| | | Lateral size | Thickness of | | | | |
|---|---|---|---|---|---|---|---|
| | Interlayer | of the | the graphene | | | | |
| | spacing, | graphene | layers | | Total | | |
| | d₀₀₂ | domains, La | stacking, Lc | | impurities | | |
| Sample ID | (nm) | (nm) | (nm) | I_{D}/I_{G} | (ppm) | O/C | H/C |
| A | 0.388 | 2.947 | 0.896 | 1.995 | 1113 | 0.007 | 0.075 |
| B | 0.395 | 2.574 | 0.873 | 3.050 | 146 | 0.013 | 0.079 |
| C | 0.388 | 2.895 | 0.954 | 2.570 | 809 | 0.025 | 0.069 |
| D | 0.382 | 2.998 | 0.984 | 2.090 | 56 | 0.023 | 0.060 |
| E | — | — | — | — | — | — | — |
| F | 0.388 | 3.383 | 0.887 | 2.117 | — | — | — |
| G | 0.386 | 2.684 | 0.973 | 2.196 | — | — | — |
| H | 0.384 | 3.481 | 1.022 | 2.134 | 1860 | 0.000 | 0.142 |
| Commercial Benchmark 1 | 0.384 | 3.116 | 0.986 | 2.449 | 606 | 0.006 | 0.020 |
| Commercial Benchmark 2-1 | — | — | — | — | — | — | — |
| Commercial Benchmark 2-2 | 0.372 | 3.759 | 1.006 | 2.007 | 3968 | 0.009 | 0.121 |

* ND: Not detected

Sucralose has a similar molecule structure with sucrose except for chlorine atom substitution. Sucralose is synthesized by the selective chlorination of sucrose in a multistep route that substitutes three specific hydroxyl groups with chlorine atoms.

Hard carbon derived from allulose, stereoisomer of sucrose, did not show as high battery performance as sucralose (Table 3).

In the examples below, allulose was dewatered at about 185° C. and pyrolyzed at 1100° C. showed slightly lower electrochemical results than allulose dewatered at 145° C. and pyrolyzed at 1100° C. The first sodiation specific capacities of allulose (at 185/1100) and allulose (at 145/1100) were 292 and 315 mAh/g, respectively, and the initial Coulombic efficiency 70.7% and 77.0%, respectively.

Allulose pyrolyzed at 1400° C. showed high reversible capacity (233 mAh/g) and the highest initial Coulombic efficiency (81.2%) among the other allulose-derived hard carbon samples.

TABLE 3
Comparison of hard carbons derived from sucrose, sucralose, and allulose with commercially available hard carbon.

| | | | | | | First | | |
|---|---|---|---|---|---|---|---|---|
| | | | Dewater/ | | | specific | | |
| | | | Carbonization | Pyrolysis | Pyrolysis | sodiation | Reversible | Irreversible |
| | Raw | | temperature | temperature | ramp rate | capacity | capacity | capacity |
| Sample ID | material | Additive | (° C.) | (° C.) | (° C.) | (mAh/g) | (mAh/g) | (mAh/g) |
| | Sucrose | — | 145 | 1100 | 2.5-1-2.5 | 320 | 253 | 67 |
| | Sucrose | — | 185 | 1100 | 2.5-1-2.5 | 335 | 269 | 66 |
| | Sucrose | — | 185 | 1250 | 2.5-1-2.5 | 287 | 213 | 74 |
| | Sucrose | — | 185 | 1250 | 2.5-1-2.5 | 291 | 233 | 59 |
| A | Sucrose | — | 185 | 1400 | 2.5-1-2.5 | 336 | 289 | 47 |
| | Sucrose | — | 185 | 1400 | 2.5-1-2.5 | 361 | 281 | 80 |
| | Sucrose | — | 185 | 1400 | 0.5 | 359 | 303 | 56 |
| | Sucrose | Oxalic acid | 145 | 1400 | 2.5-1-2.5 | 333 | 280 | 53 |
| | Sucrose | — | 145 | 1100 | 2.5-1-2.5 | — | — | — |
| | Sucrose | — | 145 | 1250 | 2.5-1-2.5 | — | — | — |
| | Sucrose | — | 145 | 1400 | 2.5-1-2.5 | — | — | — |
| B | Sucralose | — | 185 | 1100 | 2.5-1-2.5 | 386 | 298 | 88 |
| C | Sucralose | — | 185 | 1250 | 2.5-1-2.5 | 342 | 273 | 69 |
| D | Sucralose | — | 185 | 1400 | 2.5-1-2.5 | 364 | 303 | 61 |
| E | Sucralose | — | 185 | 1400 | 2.5-1-2.5 | 370 | 302 | 67 |
| F | Sucralose | — | 205 | 1400 | 2.5-1-2.5 | 377 | 298 | 79 |
| G | Sucralose | — | 160 | 1400 | 2.5-1-2.5 | 361 | 291 | 70 |
| | Sucralose | | 185 | 1400 | 0.5 | 340 | 259 | 81 |
| | Sucralose | | 185 | 1500 | 2.5-1-2.5 | 342 | 280 | 62 |
| H | Raw sugar | — | 185 | 1400 | 2.5-1-2.5 | 370 | 298 | 72 |
| | Raw sugar | — | 185 | 1400 | 2.5-1-2.5 | — | — | — |
| | Allulose | — | 145 | 1100 | 2.5-1-2.5 | 315 | 245 | 70 |
| | Allulose | — | 185 | 1100 | 2.5-1-2.5 | 292 | 206 | 86 |
| | Allulose | — | 185 | 1250 | 2.5-1-2.5 | 273 | 202 | 71 |
| | Allulose | — | 185 | 1400 | 2.5-1-2.5 | 287 | 233 | 54 |
| I | Walnut shells | | 375 | 1100 | 2.5-1-2.5 | 396 | 273 | 123 |
| | Walnut shells | | 375 | 1100 | 2.5-1-2.5 | 390 | 267 | 123 |
| J | Cherry pits | | 375 | 1100 | 2.5-1-2.5 | 368 | 260 | 108 |
| K | Brazil nut shells | | 375 | 1400 | 2.5-1-2.5 | 338 | 255 | 83 |
| | Commercial Benchmark 1 | | — | — | — | 321 | 261 | 60 |
| | Commercial Benchmark 2-1 | | — | — | — | 318 | 262 | 56 |
| | Commercial Benchmark 2-2 | | | | | 270 | 213 | 57 |

| | | BET | Effective | | Lateral size | Thickness of | | | | |
|---|---|---|---|---|---|---|---|---|---|---|
| | Initial | surface | pore | Interlayer | of the | the graphene | | | | |
| | Coulombic | area | volume | spacing, | graphene | layers | | Total | | |
| | efficiency | N₂ | CO₂ | d₀₀₂ | domains, La | stacking, Lc | | impurities | | |
| Sample ID | (%) | (m²/g) | (cm³/g) | (nm) | (nm) | (nm) | I_{D}/I_{G} | (ppm) | O/C | H/C |
| | 79.2 | 9 | 0.104 | — | — | — | — | — | — | — |
| | 80.1 | 13 | 0.130 | 0.396 | 2.715 | 0.815 | 2.756 | 442 | 0.028 | 0.144 |
| | 74.2 | 130 | 0.064 | 0.387 | 3.003 | 0.832 | — | 615 | 0.000 | 0.050 |
| | 79.9 | ND | 0.062 | 0.393 | 3.161 | 0.937 | 2.617 | — | — | — |
| A | 86.0 | 2 | 0.011 | 0.388 | 2.947 | 0.896 | 1.995 | 1113 | 0.007 | 0.075 |
| | 77.8 | 47 | 0.029 | 0.387 | 3.208 | 0.972 | 2.109 | 640 | 0.023 | 0.000 |
| | 84.4 | ND | 0.016 | 0.385 | 3.344 | 0.950 | 1.964 | 738 | 0.008 | 0.000 |
| | 84.1 | ND | 0.009 | 0.382 | 3.502 | 1.053 | — | 742 | 0.008 | 0.033 |
| | — | — | 0.100 | 0.383 | 3.019 | 0.965 | — | — | 0.017 | 0.085 |
| | — | — | 0.022 | 0.387 | 3.042 | 0.920 | — | — | 0.011 | 0.034 |
| | — | — | 0.006 | 0.378 | 3.336 | 1.031 | — | — | 0.016 | 0.000 |
| B | 77.3 | 47 | 0.148 | 0.395 | 2.574 | 0.873 | 3.050 | 146 | 0.013 | 0.079 |
| C | 80.0 | ND | 0.119 | 0.388 | 2.895 | 0.954 | 2.570 | 809 | 0.025 | 0.069 |
| D | 83.0 | 2 | 0.027 | 0.382 | 2.998 | 0.984 | 2.090 | 56 | 0.023 | 0.060 |
| E | 81.8 | ND | 0.063 | — | — | — | — | — | — | — |
| F | 79.2 | 40 | 0.064 | 0.388 | 3.383 | 0.887 | 2.117 | — | — | — |
| G | 80.7 | 29 | 0.048 | 0.386 | 2.684 | 0.973 | 2.196 | — | — | — |
| | 76.1 | 40 | 0.088 | 0.389 | 3.342 | 0.887 | 2.058 | 589 | 0.011 | 0.065 |
| | 81.8 | 2 | 0.013 | 0.385 | 3.354 | 0.982 | 1.853 | 464 | 0.008 | 0.025 |
| H | 80.6 | 3 | 0.017 | 0.384 | 3.481 | 1.022 | 2.134 | 1860 | 0.000 | 0.142 |
| | — | 27 | 0.017 | 0.379 | 2.986 | 1.007 | 2.200 | 2343 | 0.014 | 0.065 |
| | 77.0 | — | — | — | — | — | — | — | — | — |
| | 70.7 | 2 | 0.095 | 0.385 | 2.852 | 0.936 | 2.914 | 127 | 0.028 | 0.091 |
| | 74.0 | 3 | 0.027 | 0.382 | 2.852 | 0.890 | 2.569 | 157 | 0.021 | 0.057 |
| | 81.2 | 2 | 0.009 | 0.381 | 3.231 | 0.995 | 1.993 | 142 | 0.009 | 0.043 |
| I | 69.0 | 146 | 0.143 | 0.379 | 2.684 | 0.877 | 3.214 | 391 | 0.023 | 0.037 |
| | 68.4 | — | 0.135 | 0.389 | 2.761 | 1.472 | 3.129 | 2096 | 0.014 | 0.074 |
| J | 70.8 | 62 | 0.111 | 0.379 | 3.000 | 0.963 | 3.082 | 1265 | 0.025 | 0.055 |
| K | 75.5 | 33 | 0.028 | 0.381 | 3.400 | 0.940 | 2.452 | 1245 | 0.000 | 0.033 |
| | 81.3 | 7 | 0.004 | 0.384 | 3.116 | 0.986 | 2.449 | 606 | 0.006 | 0.020 |
| | 82.5 | — | — | — | — | — | — | — | — | — |
| | 79.1 | 5 | 0.008 | 0.372 | 3.759 | 1.006 | 2.007 | 3968 | 0.009 | 0.121 |

* ND: Not detected

Hard carbon precursors as described herein or sugar or sugar substituted-derived hard carbon is mixed with an additive, including, for example, oxalic acid, magnesium gluconate, multiwall carbon nanotubes (MWCNTs), transition metal cyanide coordination compounds (TMCCC), metallic and intermetallic material including but not limited to antimony, tin, phosphorus, sulfur, boron, aluminum, gallium, indium, germanium, lead, arsenic, bismuth, titanium, molybdenum, selenium, tellurium, cobalt, nickel, silicon, copper, silver, gold, and platinum in elemental and/or compound form; carbon black, graphene, graphite, activated carbon, or a combination thereof, prior to or following pyrolysis for better hard carbon crystalline structures or higher conductivity, and therefore, better battery performance.

In certain embodiments, the TMCCC is introduced as a component to the electrode, e.g., anode, in a concentration of from about 1 wt % to about 10 wt % or more. In certain embodiments, said electrodes may contain another electrochemically active electrode material including but not limited to carbons such as graphite or hard carbon, metallic and intermetallics such as sulfur and silicon, or ceramics such as transition metal oxides or phosphates, including but not limited to lithium transition metal oxides such as lithium cobalt oxide, lithium manganese oxide, or lithium nickel cobalt manganese oxide, or lithium transition metal phosphates such as lithium iron phosphate, and including but not limited to sodium transition metal oxides or phosphates, including but not limited to sodium titanium phosphate and oxides containing sodium, nickel, and optionally one or more other transition metals. The TMCCC component of said electrode would absorb water from the electrolyte as described herein, enhancing the performance of the cell or said another electrochemically active electrode material.

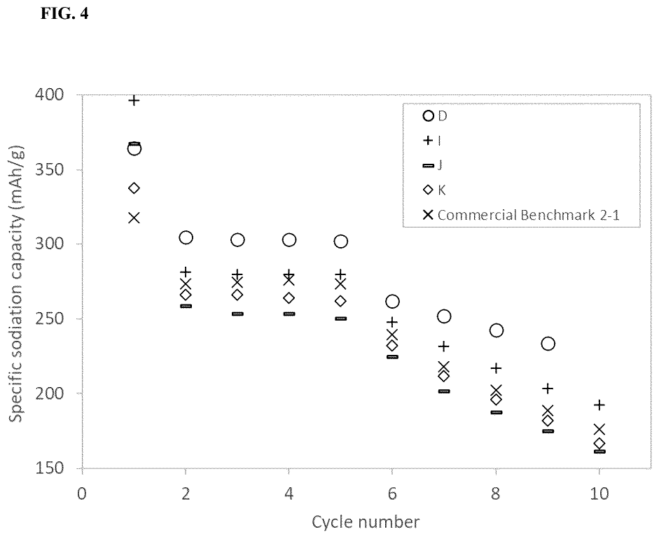

Biowaste is naturally abundant, low-cost and sustainable precursor, and contribute to reduce carbon footprint. Plant carbon source such as peanut shells, walnut shells, almond shells, apricot shells, pecan shells, macadamia nut shells, brasil nut shells, pistachio shells, cherry pits, peach pits, olive pits, low-sulfur lignin, algae, vegetable peels (such as potato and cucumber), corn stover, corn husk, agave fibers, switch grass, hemp, and vine-shoots will be used as hard carbon precursors (with or without saccharide-derived hard carbon as described herein). The biowaste hard carbons will be prepared with acid wash and drying steps to remove impurities in addition to pyrolysis and grinding (FIG. 4; Table 3).

### EXEMPLARY METHODS

### Particle Induced X-Ray Emission (PIXE)

Particle Induced X-Ray Emission (PIXE) is an exemplary technique used for determining the elemental composition of a material or sample. PIXE measures X-rays emitted from a sample due to high-energy ion bombardment. Several kinds of excitation beams produce X-rays with energies characteristic of the target elements. Photon excitation (by X-rays) gives rise to X-ray fluorescence spectroscopy. Electron excitation in a scanning electron microscope or an electron microprobe provides energy dispersive or wavelength dispersive X-ray spectroscopy (depending on the X-ray dispersion and detection method). Charged particle beams of He²⁺ or H⁺ lead to PIXE spectroscopy. In all three cases, the excitation beam removes a core electron, and X-rays are emitted with specific energies when outer shell electrons change state to fill the inner shell vacancy. The X-ray energies emitted are independent of the excitation process but are characteristic of the elements present. See, e.g., Ishii, K. PIXE and Its Applications to Elemental Analysis. Quantum Beam Science. 3(2):1-14 (2019).

PIXE has several advantages as an analytic technique. It is non-destructive and offers signal levels similar to its electron beam counterparts, but it has better signal-to-background ratios. The background in electron spectroscopy arises from bremsstrahlung, which is largely absent because He²⁺ or H⁺ ions, even at PIXE energies, have much lower velocities than electrons. Another advantage over electron induced spectroscopy is that PIXE works with insulating samples.

### BET Surface Area

Surface area is measured by nitrogen physisorption using the Brunauer-Emmet-Teller (BET) method in a Micromeritics ASAP 2420 (Norcross, GA). The Brunauer-Emmet-Teller (BET) surface can characterize the specific surface area of a material.

### Determination of Pore Volumes

Effective pore volume is measured by carbon dioxide adsorption in a Micrometrics ASAP 2020 (Norcross, GA) and obtained from MicroActive software (Micrometrics) as single point adsorption total volume of pores at p/p0<0.03 using HS-2D-NLDFT CO2 273 model (DFT type, slit geometry).

### Cell Testing

CR2032 316SS half coin cells (16 mm diameter anode, 2.01 cm²) are fabricated using the electrode compositions described above, electrolyte 1M NaClO₄ in EC:DEC (1:1 v/v)+2% FEC, and a glass separator (Whatman 1820). The cells are tested using Maccor 4000 battery tester (Tulsa, OK) at the voltage window of 0.01-2.0V (vs Na/Na⁺). Galvanostatic cycling tests are performed using C/10 CC de-sodiation and sodiation with CV to C/50 (5 cycles) and then C/5 (4 cycles). The specific current of 200 mA/g is defined as 1 C. During de-sodiation step, sodium ions are released from the hard carbon and plated on top of the Na metal counter electrode. During sodiation step, sodium ions are stripped from the Na metal counter electrode and inserted into the hard carbon. The reversible specific capacity is the material can be delivered by electrochemical reaction per gram of material during de-sodiation step and measured in ampere hours per gram (Ah/g) or milliampere hours per gram (mAh/g).

### REFERENCES

The following references are incorporated herein by reference in their entirety for all purposes.
WO2017060718
WO2017060718
US 2023/0066473
U.S. Pat. No. 7,541,312
Tonnoir et al. (2023) Pyrolysis temperature dependence of sodium storage mechanism in non-graphitizing carbons. Carbon. 208:216-226. DOI: 10.1016/j.carbon.2023.03.055
Kamiyama et al. (2021) MgO-Template Synthesis of Extremely High-Capacity Hard Carbon for Na-Ion Battery. ACIE. 60(10):5114-5120. DOI: 10.1002/ange.202013951.
Bommier et al. (2014) Predicting capacity of hard carbon anodes in sodium-ion batteries using porosity measurements. Carbon. 76:165-174. DOI: 10.1016/j%20.
Suresh Babu et al. (2014) Hard carbon and carbon nanotube composites for the improvement of low-voltage performance in Na ion batteries. J. Electrochem. Soc. 161(6):A1045-A1050. DOI: 10.1149/2.075406jes.
Buiel et al. (1998) Reduction of the Irreversible Capacity in Hard-Carbon Anode Materials Prepared from Sucrose for Li-Ion Batteries. J. Electrochem. Soc. 145(6):1977-1981. DOI 10.1149/1.1838585.

What is claimed is:

1. An electrochemically active anode material comprising at least one saccharide-derived hard carbon.

2. The electrochemically active anode material of claim 1, wherein the saccharide-derived hard carbon comprises at least one of a monosaccharide, disaccharide, oligosaccharide, polysaccharide, saccharide substitute or combination thereof.

3. The electrochemically active anode material of claim 1, wherein the saccharide-derived hard carbon comprises at least one of sucrose, sucralose, allulose or a combination thereof.

4. The electrochemically active anode material of claim 3, wherein the saccharide-derived hard carbon comprises at least one of sucralose, allulose or a combination thereof.

5. The electrochemically active anode material of claim 4, wherein the saccharide-derived hard carbon has an average particle size (D₅₀) of from about 2 μm to about 50 μm.

6. The electrochemically active anode material of claim 5, wherein the saccharide-derived hard carbon has less than 1860 ppm of total impurities as determined by proton-induced X-ray emission (PIXE).

7. The electrochemically active anode material of claim 6, wherein the saccharide-derived hard carbon comprises an effective pore volume as determined by carbon dioxide adsorption (p/p₀<0.03) of from 0.011 to 0.148 cm³/g.

8. The electrochemically active anode material of claim 7, wherein the saccharide-derived hard carbon comprises a nitrogen Brunauer-Emmett-Teller (BET) specific surface area of less than or equal to 47 m²/g.

9. The electrochemically active anode material of claim 8, wherein the anode material comprises from about 85 wt % to about 95 wt % of a saccharide-derived hard carbon.

10. The electrochemically active anode material of claim 9, wherein the anode material comprises from about 1 wt % to about 5 wt % carbon black, and from about 1 wt % to about 5 wt % binder.

11. The electrochemically active anode material of claim 10, wherein the binder is a polymer.

12. The electrochemically active anode material of claim 11, wherein the polymer binder comprises a fluoropolymer binder, e.g., a thermoplastic fluoropolymer, a cellulosic binder, e.g., carboxymethyl cellulose, or a combination thereof.

13. The electrochemically active anode material of claim 12, wherein the fluoropolymer binder comprises polyvinylidene fluoride or polyvinylidene difluoride (PVDF).

14. A sodium-ion battery (SiB) comprising an electrochemically active anode material comprising a saccharide-derived hard carbon, a cathode, and an electrolyte.

15. The SiB of claim 14, wherein the saccharide-derived hard carbon comprises at least one of a monosaccharide, disaccharide, oligosaccharide, polysaccharide, saccharide substitute or combination thereof.

16. The SiB of claim 15, wherein the saccharide-derived hard carbon comprises at least one of sucrose, sucralose, allulose or a combination thereof.

17. The SiB of claim 16, wherein the saccharide-derived hard carbon comprises at least one of sucralose, allulose or a combination thereof.

18. The SiB of claim 17, wherein the saccharide-derived hard carbon has an average particle size (D₅₀) of from about 10 μm to about 20 μm.

19. The SiB of claim 18, wherein the saccharide-derived hard carbon has less than 1113 ppm of total impurities as determined by proton-induced X-ray emission (PIXE).

20. The anode material of any preceding claim, wherein the saccharide-derived hard carbon has improved sodiation capacity, Coulombic efficiency, or both relative to a non-saccharide-derived hard carbon.

21. A method of making a saccharide-derived hard carbon active anode material as described herein, comprising the steps of:
i. dewatering a saccharide precursor material;
ii. milling the dewatered material;
iii. pyrolyzing the milled material in the absence of oxygen; and
iv. optionally, further milling the pyrolyzed material.

22. The method of claim 21, wherein step (ii) includes milling the dewatered material to an average particle size (D₅₀) of from about 30 μm to about 100 μm.

23. The method of claim 21, wherein step (iv) includes milling the pyrolyzed material to an average particle size (D₅₀) of from about 15 μm to about 25 μm.

24. The method of claim 21, wherein step (iii) includes pyrolyzing the material at a temperature of from 1100° C. to about 1400° C.

25. The electrochemically active anode material of claim 1, further comprising at least one additive comprising oxalic acid, magnesium gluconate, or multiwall carbon nanotubes (MWCNTs), transition metal cyanide coordination compound (TMCCC), metallic and intermetallic material including but not limited to antimony, tin, phosphorus, sulfur, boron, aluminum, gallium, indium, germanium, lead, arsenic, bismuth, titanium, molybdenum, selenium, tellurium, cobalt, nickel, silicon, copper, silver, gold, and platinum in elemental and/or compound form; carbon black, graphene, graphite, activated carbon or a combination thereof.
